(19) United States
(12) Patent Application Publication
(10) Pub. No.: US 2025/0283851 A1
(43) Pub. Date: Sep. 11, 2025

(54) REMOTE VERIFICATION OF CALIBRATION

(71) Applicant: Pipeline Supply & Service, LLC, Houston, TX (US)

(72) Inventors: Ronald Dean Brooks, Houston, TX (US); James Jeffery Campbell, Houston, TX (US)

(73) Assignee: Pipeline Supply & Service, LLC, Houston, TX (US)

(21) Appl. No.: 19/070,074

(22) Filed: Mar. 4, 2025

Related U.S. Application Data
(60) Provisional application No. 63/562,541, filed on Mar. 7, 2024.

(51) Int. Cl. G01N 27/61

(52) U.S. Cl. CPC G01N 27/61

(57) ABSTRACT

In general, in one aspect, embodiments relate to a method of remotely verifying the calibration of a high voltage spark detector, that includes switching between a normal signal path and a pre-calibrated reference standard, comparing the normal signal path to the pre-calibrated reference, and remotely verifying the calibration of the high voltage spark detector, based at least in part on the comparison between the normal signal path and the pre-calibrated reference standard.

### CROSS REFERENCE TO RELATED APPLICATIONS

This application claims the priority of U.S. Provisional Patent Application No. 63/562,541, filed Mar. 7, 2024, which is incorporated by reference in its entirety.

### BACKGROUND

Pipelines are often used to carry various materials including crude oil, refined petroleum, liquified petroleum gas, natural gas, water, hydrogen, slurries, and the like. The pipelines may be disposed above or below ground and are subject to corrosion by corrosive substances such as water present in the natural environment. To address this issue, industrial practices usually involve applying a protective coating to the external surface of the pipelines to limit the exposure of the naked pipelines to these corrosive substances. One problem is that defects (e.g., voids, pinholes, bubbles, areas of thinning of the protective coating, foreign particulates, etc.) may be present in these protective coatings. These defects may defeat the purpose of the protective coating by providing the corrosive substances with an access point to the underlying pipeline, thus allowing the corrosion to occur. Premature corrosion of a pipeline reduces its lifetime expectancy resulting in increased cost.

To detect these defects, handheld high voltage [e.g., at least 1 kilovolts (kV)] spark generators, commonly referred to as Holiday Detectors are used. These devices are often used to probe the outer surface of conductive substrates (e.g., pipelines) by applying a voltage to the outer surface with an electrode and connecting the conductive substrate to a ground cable. When the electrode is applied to the protective coating, the protective coating acts as a dielectric material and prevents current from flowing into the conductive substrate; however when the electrode is applied to an area in the vicinity of a defect, current flows from the electrode to the conductive substrate, resulting in a short circuit and thus an arc voltage or “spark.” This arc voltage is detectable and may be used to estimate the general location of the defect. Once found, the area hiding the defect may be marked by hand by an operator (e.g., and then sandblasted), and a new layer of protective material (e.g., referred to as patch) is applied to the area to prevent future corrosion and thus promote the desired longevity of the conductive substrate.

As indicated, holiday detectors are handheld high voltage spark generators that are used to detect defects in the outer protective coating (e.g., insulative coating) applied to conductive substrates (e.g., pipelines, storage tanks, commercial roofs, etc.). These instruments are typically calibrated in a laboratory to conform to standards set by National Institute of Standards and Technology (NIST). Calibration intervals (e.g., yearly) requiring re-calibration of the instruments are stipulated by the industry. Calibrating or re-calibrating these instruments usually requires shipping the instruments to a separate calibration facility, e.g., an accredited calibration facility, the original equipment manufacturer (OEM) facility, an OEM qualified depot, etc. An instrument is then calibrated at the calibration facility and the accuracy of the calibration is tested, and a certification of calibration is issued for the instrument. Following this, the instrument is shipped back to the customer. Shipping costs may be substantial, especially if shipped overseas. Further, the instrument is unavailable for use while being shipped back and forth, which may result in non-productive downtime (NPT) and loss of revenue.

### BRIEF DESCRIPTION OF THE DRAWINGS

These drawings illustrate certain aspects of some of the embodiments of the present invention and should not be used to limit or define the invention.

FIG. 1 illustrates a system for detecting one or more defects in a protective coating of one or more conductive substrates in accordance with some examples of the present disclosure.

FIG. 2 is a block diagram for an electronics configuration for remotely verifying the calibration of an instrument in accordance with some examples of the present disclosure.

FIG. 3 is a workflow for remotely verifying the calibration of a high voltage spark detector, in accordance with some embodiments of the present disclosure.

FIG. 4 is a workflow for pre-calibrating a reference standard of a high voltage spark detector for later remote verification of calibration, in accordance with some embodiments of the present disclosure.

### DETAILED DESCRIPTION

Disclosed herein are methods and systems for performing remote verification of calibration of electronic instruments, and more particularly, example embodiments disclose methods and systems for remotely verifying the calibration of Holiday Detectors. As used herein, a “Holiday Detector,” or “high voltage spark detector” refers to a device for detecting one or more defects in the protective coating of a conductive substrate, and that includes electronics configured to detect the arc voltage between a conductive probe and the conductive substrate. A high voltage spark detector can be a “high voltage spark generator” in facilitating generation of a spark. A defect (flaw) in the coating can leave the substrate poorly protected, or in some cases completely exposed. These defects (flaws) may be referred to as holidays, discontinuities, pinholes, etc. and are often very small or invisible to the naked eye. Thus, defect (flaw) detectors may be beneficial. In the relevant art, a holiday may be a discontinuity in coating, an area of insufficient coating film thickness, a pinhole or crack within the coating, an improper adhesion or bonding of the coating, and so forth.

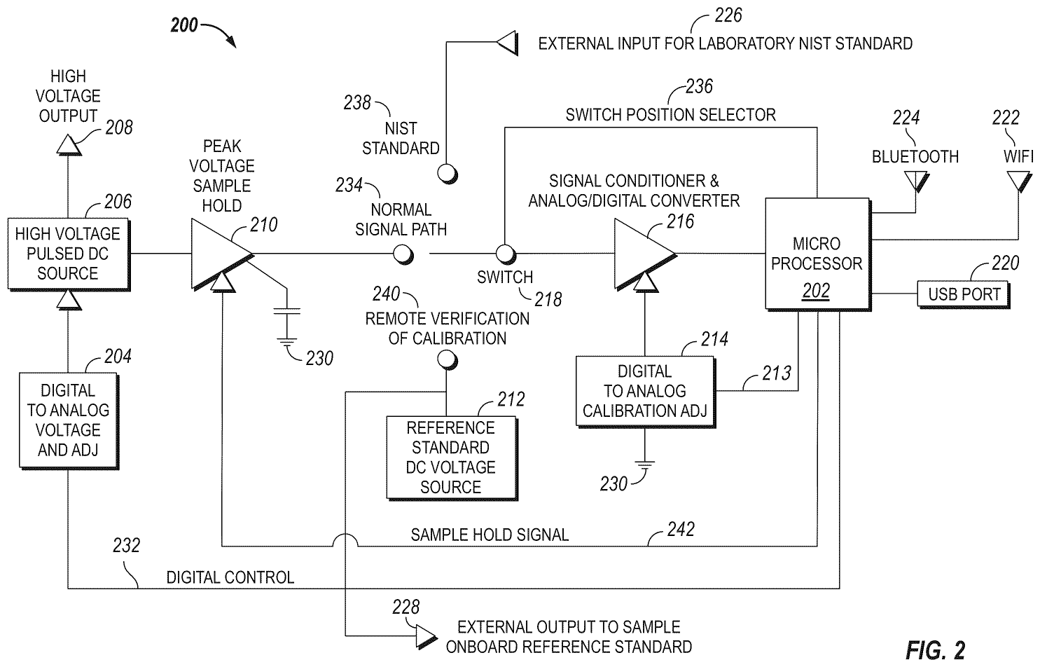

As alluded to previously, significant shipping costs and NPT may be associated with conventional means of certifying the calibration of these devices. The principles and teachings disclosed may eliminate these shipping costs and NPT by providing means to verify calibration of the devices remotely. Advantageously, the verification may be performed remotely at a work site or user facility without the need to ship the devices to a separate calibration facility. “Work site” in this context refers to a field location having the conductive substrate(s) with a dielectric coating to be tested for defects by the high voltage spark detector. The work site may have access to the internet or cellular communication, and the like. The techniques are also applicable to sites or facilities (e.g., of the owner, operator, or user of the high voltage spark generator) generally that are remote from the calibration entity (e.g., at OEM facility or OEM authorize facility). The sites or facilities (e.g., of the owner, operator, or user of the high voltage spark generator) can have access to the internet or cellular communication, and so on. In some examples, the calibration of a high voltage spark detector may be verified remotely in the absence of the original, traceable calibration standard (e.g., NIST standard of FIG. 2 having drawing reference numeral 238).

In implementations, the present techniques may include a detector, an electrode (e.g., a conductive coil), a ground wire, and electronics to detect (including to localize [locate]) defects in a protective coating on a conductive substrate, e.g., a pipeline. The detector can be labeled as a spark generator in the sense of applying a voltage to the electrode that results in a spark between the electrode and the conductive substrate at a defect in the protective coating. The systems, apparatuses, and methods of the present disclosure include or involve electronics for remotely calibrating the detector (e.g., a high voltage spark generator).

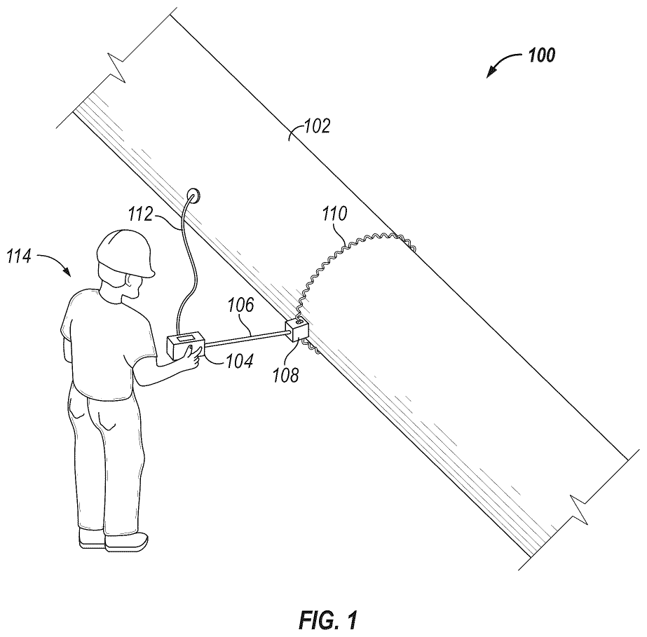

FIG. 1 illustrates system 100 for detecting defects in a protective coating on a conductive substrate of a pipeline 102 in accordance with examples of the present disclosure. The pipeline 102 may generally be a conduit (e.g., metal) that is electrically conductive and in which a protective coating (generally not electrically conductive) is on an external surface of the conduit. The coating may be protective, for example, in protecting against external environmental corrosion of the pipeline 102. Thus, to provide protection includes to coat the surface of a conductive material with a non-conductive material that creates a barrier. The protective coatings may be, for example, thin film epoxy, thick coal tar, and other materials.

The protecting coating may be applied to the external surface of the pipeline 102, for example, by spraying or brushing. As the coating is applied to the surface, defects can become prevalent due, for instance to the lack of cleanliness of the surface, dust, moisture, inclusions, pinholes, thinning of coating, oil or grease, and other debris. These defects should be located and removed, and the protective surface coating reapplied, for instance, to maintain the life expectancy of the pipeline 102.

As illustrated, the system 100 may include a detector 104 (e.g., holiday detector, high voltage spark generator) connected to a conductive coil 110 (e.g., an electrode such as a spring electrode) by a wand 106. The detector 104 may have a housing and be coupled to a power source. In operation, the detector 104 may act as a spark generator (e.g., a high voltage spark generator) in applying a voltage to the conductive coil 110 that causes a spark between the conductive coil 110 and the pipeline 102 conduit (e.g., metal that is electrically conductive as a conductive substrate) at a defect in the protective coating on the pipeline 102 conduit. The detector 104 may include sensors inside the detector 104 housing to sense or detect a defect in the protective coating.

The detector 104 may include electronics generally in the detector 104 housing. For instance, the electronics (of detector 104) may include a hardware processor (e.g., microprocessor) and memory storing code (logic, instructions) executable by the processor. The electronics may include circuitry such as that depicted in FIG. 2 or similar circuity. The code (logic, instructions) stored in memory and executable by the processor and along with other electronics or circuitry may provide for or facilitate remote calibration of the detector 104. In implementations, the positions of the located defects along the pipeline 102 may be saved (stored) in detector 104 memory as collected during operation and then downloaded from the memory to other computers. In implementations, certain electronics may be situated in a housing of the conductive coil 110 giving the conductive coil 110 as a smart electrode.

A rotatable coupling 108 may facilitate the conductive coil 110 to rotate to traverse (e.g., longitudinally traverse) the pipeline 102. As indicated, in operation, a high voltage is applied to the conductive coil 110 by a power source (e.g., a battery) energetically coupled to conductive coil 110 via the detector 104. This voltage may be labeled as the electrode voltage or the inspection voltage. The power source may be, for example, a battery (e.g. attached to the detector 104 and carried by an operator 114). An operator 114 holding the detector 104 may walk along pipeline 102 to apply forward movement to the wand 106 and thus to conductive coil 110. The detector 104 is additionally electrically coupled to pipeline 102 via a ground cable 112. Encountering a defect with conductive coil 110 amounts to the completion of a circuit between the power source, conductive coil 110, pipeline 102, and ground cable 112 resulting in an arc voltage (“spark”) between conductive coil 110 and pipeline 102. In some examples, the spark may be audibly detectable by operator 114 if the voltage differential between the conductive coil 110 and the pipeline is high enough. System 100 includes electronics (e.g., of the detector 104) configured to detect the spark and may further include hardware to sound an alarm intended to alert an operator of the defect based on detecting of the spark. System 100 may further include electronics (e.g., of the detector 104) for counting defects, collecting and storing data, transmitting data, and detecting circumferential location of the defect, as discussed in U.S. patent application Ser. No. 18/815,411, herein incorporated by reference in its entirety. These electronics may be disposed within a housing of detector 104 and may include one or more processors and memory, and so forth. Again, the system 100 may include electronics for remotely verifying (e.g., involving evaluating, confirming, adjusting) the calibration of the detector 104.

FIG. 2 is a schematic diagram for an electronics configuration for remotely verifying (confirming including adjusting if needed to confirm) the calibration of an instrument in accordance with some examples of the present disclosure. As illustrated, electronics may include one or more microprocessors 202 and a switch 218 operable to switch between Normal Signal Path 234, external input 226, and Remote Verification of Calibration 240 which comprises Reference Standard DC Voltage Source 212.

Normal Signal Path 234 is a signal pathway between Peak Voltage Sample Hold 210 and Signal Conditioner & Analog/Digital Converter 216. As discussed above, when detector 104 (e.g., referring to FIG. 1) encounters a defect, this causes there to be a high voltage spark between a conductive probe (e.g., conductive coil 110 of FIG. 1) and the grounded conductive substrate (e.g., pipeline 102 of FIG. 1). Peak Voltage Sample Hold 210 samples and holds a high voltage associated with the spark long enough to allow it to be processed by the one or more microprocessors 202. Normal Signal Path 234 is the default configuration for day to day, routine utilization of detector 104, and which ultimately provides the circuitry that functions to detect the spark. The calibration setting of Digital to Analog Calibration ADJ 204 ensures that, of the signals conveyed along normal signal path 234, those which are relayed via Signal Conditioner & Analog/Digital Converter 216 to the one or more processors 202 have the appropriate signal strength to enable the one or more microprocessors 202 to detect the defect without being over-sensitive and giving false readings.

As alluded to, it may have been previously determined (e.g., during/following the manufacture of detector 104 at an OEM facility) that an internal electronic reference voltage standard of detector 104 comports with an NIST standard. This may have been performed, for example, at an OEM facility via external input 226 prior to sale of detector 104 to the operator (user, customer). In these examples, detector 104 may be connected to external input 226, whereupon switch position selector 236 causes switch 218 to disconnect from normal signal path 234 and connect to external input 226. External input 226 may be, or correspond to, a laboratory NIST voltage standard (as indicated by drawing reference numeral 238), for example. NIST voltage standard 238 may then be connected to Signal Conditioner & A/D Converter 216, and one or more microprocessors 202 may adjust Digital to Analog Calibration Adj 214 to thereby pre-calibrate the reference voltage standard. This pre-calibrated standard may later be used during remote verification of the calibration. Output of Reference Standard DC Voltage Source 212 is connected to a highly accurate NIST traceable voltage measuring device via an external port 228 to measure its accuracy. Digital to Analog Calibration Adj 214 may be adjusted iteratively until pre-calibration of Signal Conditioner & Analog/Digital Converter 216 is brought within an acceptable tolerance range to the NIST standard 238.

Calibration of detector 104 (e.g., referring to FIG. 1) may be verified remotely by an operator to determine if the calibration is accurate and reliable. Internal circuitry onboard detector 104 may be used to perform the verification, e.g., at the work site comprising pipeline 102. To perform the remote verification of the calibration, an operator may connect the one or more microprocessors 202 to at least one of a USB port 220, Wi-Fi 222, Bluetooth 224, and any combination thereof. The one or more processors 202 may thus be accessed from the internet, e.g., via a local computing device. The operator may be (or may have been) prompted to provide an encrypted key code, e.g., supplied by the OEM, which may require the operator, in some examples, to subscribe to a service offered by the OEM. Thus, in some examples, once a valid key code is confirmed, remote verification of calibration may begin.

Remote verification of the calibration includes comparing signals of Normal Signal Path 234 to Reference Standard DC Voltage Source 212. Reference Standard DC Voltage Source 212 produces external output 228 which has a specific voltage corresponding to an onboard reference standard. As discussed, this onboard reference standard is an internal electronic reference voltage standard previously verified as being within tolerance of an NIST standard. As switch position selector 236 switches between Normal Signal Path 234 and Reference Standard DC Voltage Source 212, the one or more processors may adjust Digital to Analog Voltage Adj 204 connected to High Voltage Pulsed DC Source 206. This may be performed iteratively until the entire circuit is within an acceptable tolerance. An “acceptable tolerance” in this context is a maximum allowable tolerable voltage difference between Normal Signal Path 234 and external output 228. Communication from a local computer (e.g., via USB 220, Wi-Fi 222, Bluetooth 224, etc.) may control software of the one or more processors 202 to force switch 218 into any one of the three positions, and thus one or more operations executed on the circuit by one or more processors 202 may be controlled over the internet. Ultimately, this allows the operator to confirm that the calibration of detector 104 is within the tolerance of an initial OEM calibration using the internal circuitry of detector 104 (e.g., referring to FIG. 1) without needing to ship the detector 104 to a separate calibration facility. Upon verifying the calibration, a certificate of calibration may be issued and forwarded (e.g., automatically) to the operator if the calibration is within a pre-determined tolerance.

Thus, software downloaded to the detector 104 (e.g., referring to FIG. 1), such as to the one or more microprocessors 202 and associated memory, may control the switch 218. To perform the remote verification of calibration, a switch position selector 236 of the software is configured to disconnect from normal signal path 234 and connect to the remote verification of calibration 240 at switch 218, which may be performed multiple times for a single calibration. If remote verification of calibration fails and the instrument cannot be brought back into tolerance, it may be necessary in this situation to ship the high voltage spark detector to an OEM facility, where pre-calibration may be repeated using external port 228 and the original, traceable NIST standard 238. In such cases, switch 218 may be used to connect the detector 104 (e.g., referring to FIG. 1) to external port 228. Software installed on the one or more microprocessors 202 may be updated to bring the instrument back into tolerance. Also, if the reference voltage standard (e.g., Reference Standard DC Voltage Source 212) loses accuracy over time (e.g., falls out of original specification), it can be tested against and/or replaced by NIST standard 238 at the OEM facility.

As illustrated, a sample hold signal 242 is relayed between peak voltage sample hold 210 and microprocessor(s) 202. Signal condition & analog/digital convertor 216 is connected to Digital to Analog Calibration Adj 214. A Calibration Adjust signal 213 is relayed between Digital to Analog Calibration Adj 214 and the one or more microprocessors 202. There may also be digital control 232 between Digital to Analog Voltage & Adj 204. Also, peak voltage sample hold 210 may be connected to high voltage pulsed DC source 206 and ground 230. Peak voltage sample hold 210 may be connected to a normal signal path 234. A switch position selector 236 of the one or more microprocessors 202 may switch between the normal signal path 234, NIST standard 238, and a remote verification of calibration 240.

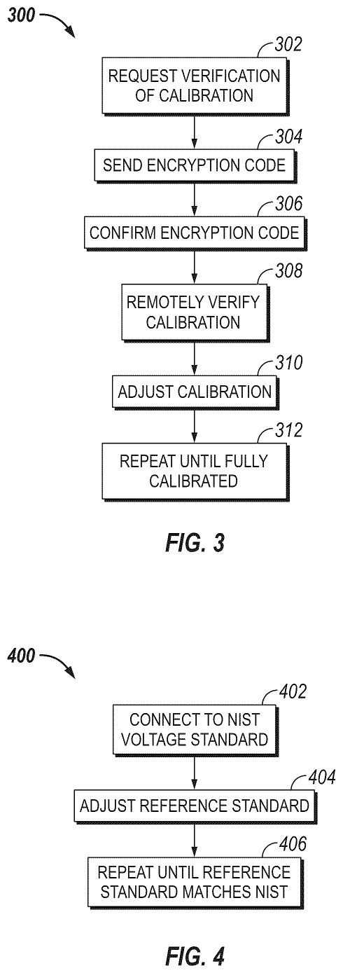

FIG. 3 is a workflow 300 for remotely verifying the calibration of a high voltage spark detector. At block 302, an owner or operator (user) of the high voltage spark detector (e.g., detector 104 of FIG. 1) requests verification of the calibration of the high voltage spark detector. The request may be sent electronically by the user of the high voltage spark detector to the entity (e.g., OEM or OEM authorized facility) that will perform the remote calibration. Therefore, the request may be received by the entity (a facility that provides calibration) performing the remote calibration, such as at the OEM or OEM depot.

At block 304, in response to receipt of the request sent in block 302, a code (e.g., an encryption key code) is sent (relayed), such as from the calibration entity, to the user (owner or operator of block 302) situated remotely from the calibration entity. The user receives the code.

At block 306, the user sends (enters) the code to the calibration entity as confirmation. The calibration entity receives the confirmation and, in response, initiates the remote calibration as presented at block 308.

At block 308, the calibration entity starts remote verification of calibration. In response to block 306, a local computing device (at the remote owner or operator site) is instructed over a network by the calibration entity to command software installed on one or more microprocessors of the high voltage spark detector to disconnect a switch from a normal signal path to a reference standard voltage source (e.g., Reference Standard DC Voltage Source 212 of FIG. 2). This action can be characterized as part of the remote verification. The reference standard voltage source may have been pre-calibrated (e.g., according to workflow 400 of FIG. 4). At block 308, the remote verification of the calibration is performed by the calibration entity. The remote verification may confirm that the high voltage spark generator is within appropriate or desired calibration (e.g., if the normal signal path signal is within an acceptable tolerance of the reference standard voltage source signal) and thus no adjustment of the calibration is needed. The remote verification may determine the one or more microprocessors adjust the respective calibration device (e.g., Digital to Analog Voltage & Adj 204 of FIG. 2) if the normal signal path signal is not within an acceptable tolerance of the reference standard voltage source signal.

At block 310, block 308 is repeated iteratively until the normal signal path signal is within the acceptable tolerance, and thus the high voltage spark detector is calibrated as desired (within tolerance) as indicated in block 312. Workflow 300 may further include an additional action of detecting defects in a non-conductive coating of a conductive substrate with the high voltage spark detector after remotely verifying the calibration is within the acceptable tolerance. The remote verification of calibration of block 308 can be characterized as additionally including block 310 and 312. The verification (verifying) of the calibration can be broadly construed as evaluating the calibration including (1) confirming the calibration is acceptable or (2) confirming that the calibration is not acceptable and then adjusting the calibration until the calibration is confirmed as acceptable.

FIG. 4 is a workflow 400 for pre-calibrating the reference standard noted in FIG. 3 for later remote verification of calibration. The pre-calibrating may be, for example, by the OEM at an OEM facility using the reference standard. The pre-calibrating (or initial calibration) may be performed before the high voltage spark generator is sold or delivered to the user. It should be understood that later remote verification of calibration may be based on the pre-calibrating, and thus that any recalibration performed following the remote verification of calibration may be a calibration process separate and different from the pre-calibration.

At block 402, a local computing device commands one or more microprocessors of the high voltage spark detector to disconnect a switch from a normal signal path and connect to an external input (e.g., external input 226 of FIG. 2). The external input may include an NIST voltage standard, which connects to a signal conditioner and converter device (e.g., Signal Conditioner & Analog/Digital Converter 216 of FIG. 2).

At block 404, the one or more microprocessors make one or more adjustments to the calibration of a signal conditioner and converter device (via, e.g., Digital to Analog Calibration Adj 214) if an output (e.g., external output 228) is not within an acceptable tolerance of the NIST voltage standard. In other words, if the reference standard is deemed insufficient or inaccurate, the reference standard may be replaced by an updated reference standard that comports with the NIST standard. At block 406, the actions of block 404 are repeated iteratively until the signal conditioner and converter device are within the acceptable tolerance of the NIST standard.

An embodiment is a method of pre-calibrating an onboard reference standard of a high voltage spark detector for later remote verification of calibration of the high voltage spark detector. The method includes switching between a Reference Standard DC Voltage Source and an external input to connect a Signal Conditioner & Analog/Digital Converter device to a NIST voltage standard. The method includes adjusting a Digital to Analog Calibration Adj device to alter the Signal Conditioner & Analog/Digital Converter device, and repeating the adjusting iteratively until the Reference Standard DC Voltage Source and the NIST voltage standard are within a specified acceptable tolerance, wherein the Reference Standard DC Voltage Source serves as the onboard reference standard for later remote verification of the calibration of the high voltage spark detector. In implementations, the method includes switching between a Normal Signal Path and the Reference Standard DC Voltage Source to remotely verify that the Normal Signal Path and the Reference Standard DC Voltage Source are within an acceptable tolerance. In implementations, the method includes re-adjusting the Digital to Analog Calibration Adj device to alter the Signal Conditioner & Analog/Digital Converter device and repeating the re-adjusting iteratively until the Reference Standard DC Voltage Source and the Normal Signal Path are within a specified acceptable tolerance, wherein the re-adjusting is performed remotely. In implementations, the later remote verification is performed at a work-site where an original source of the NIST voltage standard is absent, wherein the later remote verification of calibration includes switching between the Normal Signal Path and the Reference Standard DC Voltage Source.

Another embodiment is a method of remotely verifying calibration of a high voltage spark detector, including: receiving a request for verification of the calibration of the high voltage spark detector from a remote site in which the high voltage spark detector is situated; switching in the high voltage spark generator between a normal signal path and a pre-calibrated reference standard; and comparing the normal signal path to the pre-calibrated reference standard to remotely verify the calibration. The remote site can be, for example, a work site having a conductive substrate to be tested by the high voltage spark detector. The method can include sending a code to the remote site in response to the request, and receiving confirmation of the code from the remote site, wherein the switching and the comparing are performed in response to receiving the confirmation. The method can include transmitting an encrypted key code to an owner or operator of the high voltage spark detector at the remote site, wherein remotely verifying comprises calibration performed autonomously by the high voltage spark detector in response to the owner or operator confirming the encrypted key code. The remotely verifying of the calibration can include confirming that no adjustment of the calibration is to be implemented. The remotely verifying of the calibration can includes adjusting the calibration until the calibration is within a specified acceptable tolerance. In implementations, the remotely verifying of the calibration is performed without shipping the high voltage spark detector to an entity that performs the remote verifying of the calibration.

Yet another embodiment is a high voltage spark detector, including a housing, and electronics configured to remotely verify a calibration of the high voltage spark detector. The electronics include one or more microprocessors, a normal signal path, a pre-calibrated reference standard voltage source, and a switch configured to disconnect from the normal signal path and connect to the pre-calibrated reference standard voltage source. 12. In implementations, the electronics configured to remotely verify the calibration includes the electronics configured to switch between the normal signal path and the pre-calibrated reference standard voltage source. In implementations, the electronics configured to remotely verify the calibration includes the electronics configured to confirm as acceptable the calibration involving a circuit of the high voltage spark detector based at least in part on switching between the normal signal path and the pre-calibrated reference standard voltage source. In implementations, the electronics configured to remotely verify the calibration includes the electronics configured to re-calibrate the calibration involving a circuit of the high voltage spark detector based at least in part on switching between the normal signal path and the pre-calibrated reference standard voltage source. In implementations, at least some of the electronics are disposed in the housing. The high voltage spark detector may include a conductive probe, or configured to couple to a conductive probe. In implementations, the high voltage spark detector is configured to couple the one or more microprocessors to a network (e.g., a communication network, computer network, etc.) In implementations, the high voltage spark detector can be configured to couple the one or more microprocessors to the network via at least one of Bluetooth®, wireless fidelity (Wi-Fi), or universal service bus (USB).

Yet another embodiment is a high voltage spark detector including a housing, and electronics configured to remotely verify a calibration of a Digital to Analog Voltage ADJ device of the high voltage spark detector. In implementations, the Digital to Analog Voltage ADJ device allows for adjustable output voltage. The electronics include one or more microprocessors configured connect to a computing device connected to a network; a Normal Signal Path connecting a High Voltage Pulsed DC Source to a Signal Conditioner & Analog/Digital Converter via a Peak Voltage Sample Hold; a Reference Standard DC Voltage Source comporting with a National Institute of Standards and Technology (NIST) Standard; and a Switch Position Selector configured to iteratively disconnect a switch from the Normal Signal Path and connect the switch to the Reference Standard DC Voltage Source until the calibration is within an acceptable tolerance, wherein the disconnecting and connecting by the Switch Position Selector is controlled by the computing device over the network. In implementations, at least some of the electronics are situated in the housing. In implementations, the high voltage spark detector can be configured to couple to a conductive probe.

As discussed, the present disclosure provides methods and devices for pre-calibrating, remotely re-calibrating, and remotely verifying the calibration and/or re-calibration of, a high voltage spark detector. Advantageously, recalibration generally need not involve shipping of the high voltage spark detector to a separate calibration facility. Further advantages include reduced shipping costs, reduced NPT, minimal operator input to perform calibration, increased reliability of the high voltage spark detectors, and the ability to access calibration remotely using a network.

Implementations of operation of the high voltage spark generator to detect a defect in or of a coating on a conductive substrate, can include traversing the conductive substrate with high voltage spark generator. The high voltage spark generator has a housing and a spark generator disposed in the housing. The technique includes inducing, via the spark generator and an electrode, an arc voltage at the defect of the coating on the conductive substrate. Further, the operation includes detecting the arc voltage with a sensor associated with the high voltage spark generator, thereby detecting the defect. The method includes recording with electronics of the high voltage spark generator an electrode voltage (a numerical value of the electrode voltage) of the electrode. The electrode voltage is associated with the arc voltage. The electrode voltage (e.g., applied voltage, inspection voltage) may be characterized as associated with the arc voltage is that the electrode voltage (e.g., conductive coil voltage as an inspection voltage) may cause or result in the arc voltage. As discussed, an arc (spark) occurs when the voltage (e.g., high voltage) applied to the electrode (e.g., conductor coil) passes over a defect in the coating. The arc occurs between the electrode and the conductive substrate (e.g., metal substrate). The electrode may include a conductive coil situated on the coating during the traversing of the conductive substrate. The electrode may include an electrode housing, wherein the sensor is disposed in the electrode housing. The sensor may be a plurality of sensors to detect the arc voltage. The conductive substrate having the coating may be a conduit (e.g., pipeline). The detecting of the defect may include detecting a longitudinal location of the defect along the conduit and a circumferential location of the defect around the conduit.

It is to be understood that the present disclosure is not limited to particular devices or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method of remotely verifying calibration of a high voltage spark detector, comprising:
receiving a request for verification of the calibration of the high voltage spark detector from a remote site in which the high voltage spark detector is situated;
switching in the high voltage spark detector between a normal signal path and a pre-calibrated reference standard; and
comparing the normal signal path to the pre-calibrated reference standard to remotely verify the calibration.

2. The method of claim 1, comprising:
sending a code to the remote site in response to the request; and
receiving confirmation of the code from the remote site, wherein the switching and the comparing are performed in response to receiving the confirmation.

3. The method of claim 1, wherein remotely verifying the calibration comprises confirming that no adjustment of the calibration is to be implemented.

4. The method of claim 1, wherein remotely verifying the calibration comprises adjusting the calibration until the calibration is within a specified acceptable tolerance.

5. The method of claim 1, wherein remotely verifying the calibration is performed without shipping the high voltage spark detector to an entity that performs the remote verifying of the calibration.

6. The method of claim 1, wherein the remote site comprises a work site comprising a conductive substrate to be tested by the high voltage spark detector.

7. The method of claim 1, further comprising transmitting an encrypted key code to an owner or operator of the high voltage spark detector at the remote site, wherein remotely verifying comprises calibration performed autonomously by the high voltage spark detector in response to the owner or operator confirming the encrypted key code.

8. A high voltage spark detector, comprising:
a housing; and
electronics configured to remotely verify a calibration of the high voltage spark detector, wherein the electronics comprise:
one or more microprocessors;
a normal signal path;
a pre-calibrated reference standard voltage source; and
a switch configured to disconnect from the normal signal path and connect to the pre-calibrated reference standard voltage source.

9. The high voltage spark detector of claim 8, comprising a conductive probe.

10. The high voltage spark detector of claim 8, wherein the high voltage spark detector is configured to couple to a conductive probe.

11. The high voltage spark detector of claim 8, wherein at least some of the electronics are disposed in the housing.

12. The high voltage spark detector of claim 8, wherein the electronics configured to remotely verify the calibration comprises the electronics configured to switch between the normal signal path and the pre-calibrated reference standard voltage source.

13. The high voltage spark detector of claim 12, wherein the electronics configured to remotely verify the calibration comprises the electronics configured to confirm as acceptable the calibration involving a circuit of the high voltage spark detector based at least in part on switching between the normal signal path and the pre-calibrated reference standard voltage source.

14. The high voltage spark detector of claim 12, wherein the electronics configured to remotely verify the calibration comprises the electronics configured to re-calibrate the calibration involving a circuit of the high voltage spark detector based at least in part on switching between the normal signal path and the pre-calibrated reference standard voltage source.

15. The high voltage spark detector of claim 8, wherein the high voltage spark detector is configured to couple the one or more microprocessors to a network.

16. The high voltage spark detector of claim 8, wherein the high voltage spark detector is configured to couple the one or more microprocessors to a network via at least one of Bluetooth®, wireless fidelity (Wi-Fi), or universal service bus (USB).

17. A high voltage spark detector, comprising:
a housing; and
electronics configured to remotely verify a calibration of a Digital to Analog Voltage ADJ device of the high voltage spark detector, wherein the electronics comprise:
one or more microprocessors configured connect to a computing device connected to a network;
a Normal Signal Path connecting a High Voltage Pulsed DC Source to a Signal Conditioner & Analog/Digital Converter via a Peak Voltage Sample Hold;
a Reference Standard DC Voltage Source comporting with a National Institute of Standards and Technology (NIST) Standard; and
a Switch Position Selector configured to iteratively disconnect a switch from the Normal Signal Path and connect the switch to the Reference Standard DC Voltage Source until the calibration is within an acceptable tolerance, wherein the disconnecting and connecting by the Switch Position Selector is controlled by the computing device over the network.

18. The high voltage spark detector of claim 17, wherein the Digital to Analog Voltage ADJ device allows for adjustable output voltage.

19. The high voltage spark detector of claim 17. wherein the high voltage spark detector is configured to couple to a conductive probe.

20. The high voltage spark detector of claim 17, wherein at least some of the electronics are situated in the housing.
